(19) United States
(12) Patent Application Publication
(10) Pub. No.: US 2005/0060749 A1
(43) Pub. Date: Mar. 17, 2005

(54) Digital cable receiver

(75) Inventors: Young Jin Hong, Seoul (KR); Jung II Han, Gyeonggi-do (KR); Seung Chul Song, Gyeonggi-do (KR); Kyung Wook Shin, Gyeonggi-do (KR); Ja Hyuk Koo, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 10/943,425

(22) Filed: Sep. 16, 2004

(30) Foreign Application Priority Data
Sep. 17, 2003 (KR) 10-2003-64441

(51) Int. Cl. H04N 5/445; G06F 3/00; H04N 7/16; H04N 7/173; H04N 7/18

(52) U.S. Cl. 725/78; 725/54; 725/148; 725/118; 725/119; 725/74; 725/80

(57) ABSTRACT

A digital cable receiver, which has a simplified structure and can reduce the fabrication cost, is disclosed. The digital cable receiver includes an out-of-band (OOB) receiver receiving an out-of-band signal outputted from a cable head-end, a point of deployment (POD) interface transmitting the out-of-band signal outputted from the cable head-end and a transport stream outputted from POD module, and receiving the transport stream scrambled at the POD module, and an out-of-band (OOB) transmitter outputting the out-of-band signal outputted from the POD interface.

### CROSS-REFERENCE TO RELATED APPLICATIONS

This application claims the benefit of Korean Application No. 10-2003-064441, filed on Sep. 17, 2003, which is hereby incorporated by reference as if fully set forth herein.

### BACKGROUND OF THE INVENTION

1. Field of the Invention

The present invention relates to a cable receiver, and more particularly, to a digital cable receiver, which is connected to a point of deployment module and a cable head-end. Although the present invention is suitable for a wide scope of applications, it is particularly suitable for simplifying the overall structure and reducing the fabrication cost.

2. Discussion of the Related Art

Cable broadcasting occupies a large majority of the broadcasting market in the United States. The area of equipments including cable-broadcasting-related head-end equipments and set-top boxes are practically monopolized by two of the leading manufacturers, Motorola and Scientific Atlanta, which may be considered as an inbred area. In order to resolve such inbreeding tendencies, manufacturers have been advised to separate devices related with conditional access from the set-top boxes, starting from 2005. In the United States, an open cable standard is used for digital cable broadcasting. The open cable standard is an interface standard applied in a set-top box and a digital device of a digital cable television receiver manufactured by Cable Television Laboratories, Inc. In order to meet with the requirements of the Federal Communications Commission (FCC) regulations, the open cable standard requires a set-top box including a consumer device that does not have a conditional access function and a point of deployment (POD) having a conditional access. In other words, the open cable standard satisfies the conditions of separation of conditional access functions, purchase of consumer devices from a competitive market, compatibility with the conventional digital cable broadcasting system, and so on.

FIG. 1 illustrates standards of a general open cable standard. Referring to FIG. 1, the open cable standard includes six types of standards (i.e., OCI-H1, OCI-H2, OCI-H3, OCI-N, OCI-C1, and OCI-C2). In addition, the open cable standard further includes a host core functional (HCF) standard, wherein a basic essential function required in the consumer device (or set-top box) is defined, and a DOCSIS set-top gateway (DSG) standard required for applying a data over cable service interface specification (DOCSIS) cable modem. The OCI-C1 and OCI-C2 standards define a matching between the consumer device (or host) and a security module and define the signals being transmitted and received between the consumer device and the security module. On the other hand, the OCI-H1, OCI-H2, and OCI-H3 standards define a matching between the consumer device and an external device and define the signals being transmitted and received between the consumer device and the external device. Finally, the OCI-N standard defines a matching between the cable and the consumer device and defines the signal being transmitted and received therebetween. The OCI-N standard adopts the digital cable network interface standard (i.e., SCTE 40 2001), which is a standard decided by the Society of Cable Telecommunication Engineers (SCTE). The OCI-N also defines a signal being transmitted and received between the consumer device and the cable television (CATV) network in accordance with physical layer characteristics, transmission layer characteristics, service and related protocol characteristics, and so on.

FIG. 2 illustrates the OCI-C2 standard between a consumer device (or host) and a security model among the standards shown in FIG. 1. The OCI-C2 standard is related with contents copy-protection technology. Referring to FIG. 2, two types of copy protection systems are represented herein. The copy protection systems include a conditional access system (CAS) and a copy protection system (CPS). The conditional access system (CAS) is based on a digital cable broadcasting emission system. The copy protection system (CPS) protects the system from any illegal copy occurring between the point of deployment (POD) and the host. Herein, the POD has the function of receiving encrypted (or encoded) contents from the broadcast emission system and then selectively recovering the received encrypted contents to a general image. The POD is a separate security mobile separated from the broadcast receiving system.

FIG. 3 illustrates a connection between the subscriber terminal and a POD module. In order to convert digital contents encrypted from the broadcast emission system to plaintext digital contents, the POD of the user decrypts (or decodes) the encrypted digital contents. The decrypted contents are then encrypted once again according to an encryption method required from a copy protection system standard (i.e., CP Encryption), and the encrypted digital contents are transmitted to the host. Such encryption prevents the plaintext digital contents from being transmitted to the host from the POD. A data encryption standard (DES), which is a standard block encryption algorithm, is the encryption algorithm used in an MPEG2 transmission layer encryption between the POD and the host.

The above-described CPS may be applied in all type contents, however, not all contents are necessarily encrypted prior to transmission. More specifically, the contents that do not involve the conditional access system (e.g., public channels) can be received and provided to any individual user, whereas advanced digital contents are prevented from being illegally copied. First priority in deciding whether or not to apply copy protection encryption is given to the manufacturers of the corresponding contents. The broadcasting emission system provides copy control information (CCI), which enables the copy protection system to determine whether to allow transmission of specific contents, to the POD of the recipient for each corresponding transmitted digital content. In addition, the broadcast emission system also provides the POD with a message controlling access to advanced digital contents of each consumer or each device in private section formats within the MPEG2 transport stream (TS). Such messages are referred to an entitlement control message (ECM). The information is transmitted to the host only through a channel defined by an encrypted protocol, which can prove and support the integrity of the information being transmitted. Accordingly, the host controls the output of the corresponding contents based on the transmitted CCI.

However, the host of the related art digital cable receiver includes a plurality of chips performing various functions. Since each of the chips are be connected to each other through a plurality of interfaces, the size of the host inevitably become larger, thereby causing an increase in the fabrication cost.

### SUMMARY OF THE INVENTION

Accordingly, the present invention is directed to a digital cable receiver that substantially obviates one or more problems due to limitations and disadvantages of the related art.

An object of the present invention is to provide a digital cable receiver that can simplify the overall structure and reduce the fabrication cost.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a digital cable receiver includes an out-of-band (OOB) receiver receiving an out-of-band signal outputted from a cable head-end, a point of deployment (POD) interface transmitting the out-of-band signal outputted from the cable head-end and a transport stream outputted from POD module, and receiving the transport stream scrambled at the POD module, and an out-of-band (OOB) transmitter outputting the out-of-band signal outputted from the POD interface. In order to simplify the structure of the digital cable receiver, the OOB receiver, the OOB transmitter, and the POD interface are formed in a single chip.

The out-of-band (OOB) receiver includes a first gain amplifier amplifying the out-of-band signal outputted from the cable head-end, an A/D converter converting the out-of-band signal amplified from the first gain amplifier to a digital signal, a demodulator demodulating the signal outputted from the A/D converter, and a differential decoder decoding the signal outputted from the demodulator and transmitting the decoded signal to the POD interface. The demodulator includes a filter compensating a channel error of the signal outputted from the A/D converter, and an equalizer compensating a phase error of the signal outputted from the A/D converter. Herein, the differential decoder synchronizes the decoded signal with a clock having a cycle identical to a ½ cycle of a symbol rate. The OOB receiver may also include a gain controller controlling an amplified value given from the gain amplifier in accordance with the signal outputted from the A/D converter.

In addition, the out-of-band (OOB) transmitter includes a modulator modulating a frequency spectrum of the out-of-band signal outputted from the POD interface, a power shaper converting a level of the out-of-band signal outputted from the modulator, a D/A converter converting the out-of-band signal outputted from the modulator to an analog signal, and a second gain amplifier amplifying the signal outputted from the D/A converter, and transmitting the amplified signal to the cable head-end. The OOB transmitter may also include a digital frequency synthesizer storing data related with frequency spectrum modulating of the out-of-band signal, and transmitting the stored data to the modulator, and a power controller controlling an amplified value of the gain amplifier in accordance with the signal outputted from the POD interface.

The POD interface includes an out-of-band (OOB) multiplexer transmitting the out-of-band signal outputted from the OOB receiver to the POD module, and transmitting the outputted put-of-band signal to the OOB transmitter, a first transport stream (TS) multiplexer transmitting the transport stream outputted from the cable head-end to the POD module, and a second transport stream (TS) multiplexer receiving the transport stream outputted from the POD module. The POD interface may also include a transport stream (TS) input selector selectively transmitting the transport stream outputted from the cable head-end to the first TS multiplexer, a descrambler descrambling the transport stream outputted from the TS input selector; a connector connecting the POD module to the OOB multiplexer, the first TS multiplexer, and the second TS multiplexer, and at least one switch sensing the connection between the POD module and the connector.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 illustrates standards of a general open cable standard;

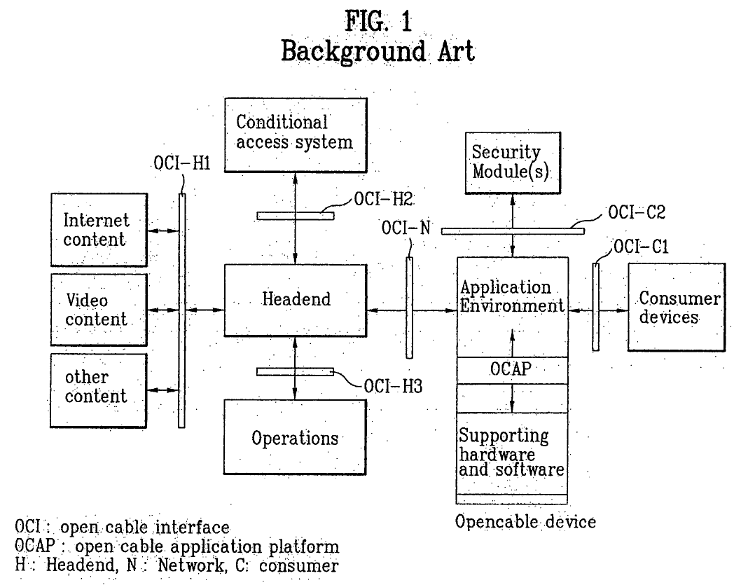

FIG. 2 illustrates the standard (e.g., OCI-C2) between a consumer device (or host) and a security model among the standards shown in FIG. 1;

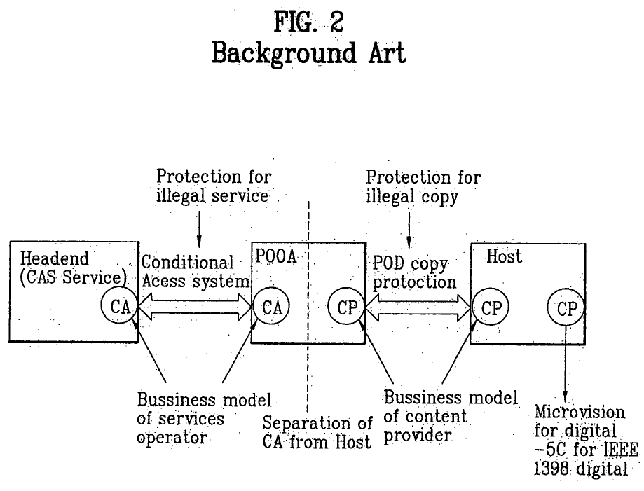

FIG. 3 illustrates a connection between the subscriber terminal and a POD module;

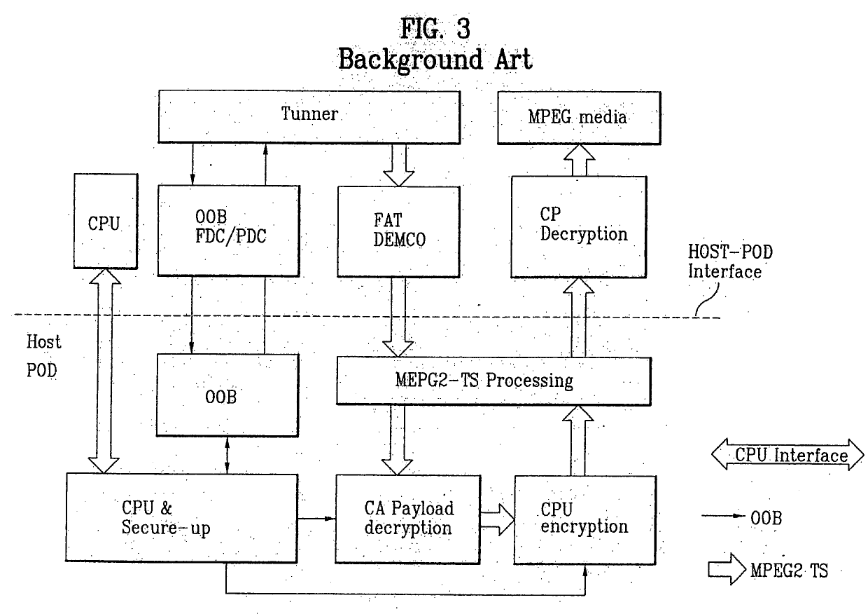

FIG. 4 illustrates an open cable system according to the present invention; and

FIG. 5 illustrates a digital cable receiver according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

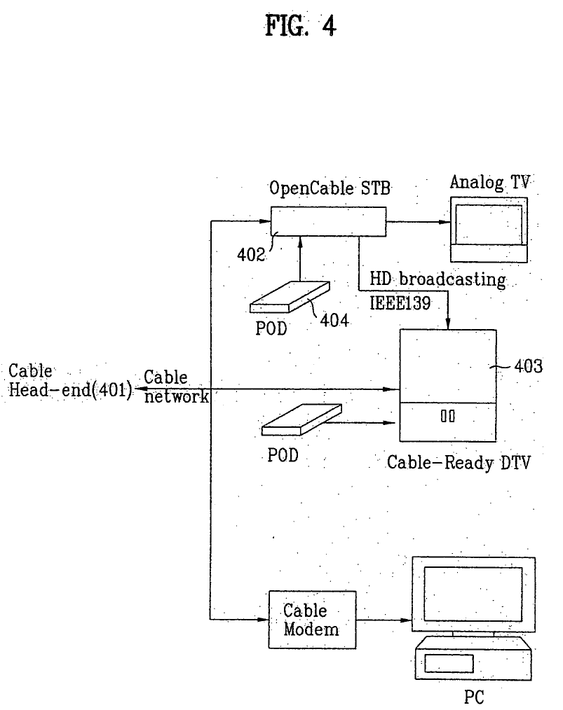

FIG. 4 illustrates an open cable system according to the present invention. Referring to FIG. 4, a cable head-end 401 transmits an in-band signal including an MPEG-2 transport stream (TS) to a digital cable receiver, such as an open cable set-top box 402, a cable ready digital television (DTV) 403, and so on. The MPEG-2 transport stream includes an audio signal and a video signal. A plurality of quadrature amplitude modulation (QAM) receivers in the set-top box 402 and the cable ready DTV 403 demodulate the in-band signals received from the cable head-end 401. The QAM receivers receive control signals from the cable head-end 401. The control signal can be transmitted and received in both directions between the cable head-end 401 and the QAM receiver, when the control signal is out-of-band (OOB). In addition, a point of deployment (POD) module or a POD card 404 is connected to the QAM receivers in order to represent a conditional access system (CAS) and a copy protection system (CPS).

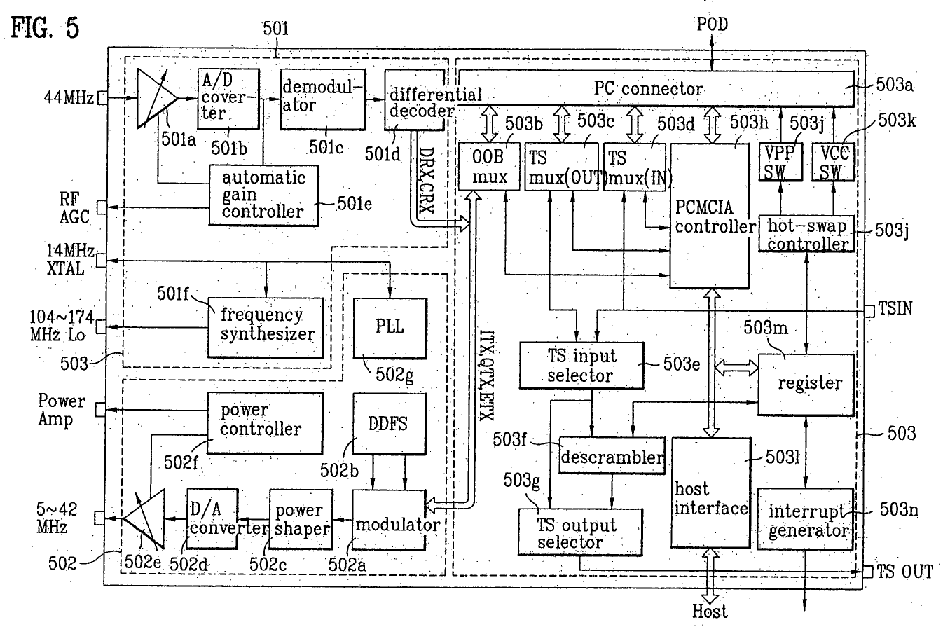

FIG. 5 illustrates a digital cable receiver according to the present invention. The digital cable receiver according to the present invention includes an out-of-band (OOB) receiver 501 receiving an out-of-band control signal from the cable head-end 401, an OOB transmitter 502 transmitting a control signal to the cable head-end 401, and a POD interface unit 503 providing an interface function between the POD module 404 and a personal computer (PC) memory card. The OOB receiver 501, the OOB transmitter 502, and the POD interface unit 503 are formed in a single chip. Herein, the OOB receiver 501 includes a first gain amplifier 501a, and A/D converter 501b, a demodulator 501c, a differential decoder 501d, an automatic gain controller 501e, and a frequency synthesizer 501f.

The first gain amplifier 501a amplifies the control signal received at a bandwidth of 44 megahertz (MHz) from the cable head-end 401 to a level suitable for the digital cable receiver. The A/D converter 501b first converts the amplified control signal to a digital signal and, then, transmits the converted control signal to the automatic gain controller 501e and the demodulator 501c. The automatic gain controller 501e controls the amplified value of the first gain amplifier 501a based upon the signal outputted from the A/D converter 501b. The demodulator 501c receives the amplified control signal from the A/D converter 501b and, then, converts the passband control signal to a baseband control signal through a long loop carrier recovery in order to compensate a channel error of the received control signal and to equalize the received control signal. The demodulator 501c then uses a timing recovery loop in order to resample the received control signal and, then, passes the control signal through a square-root Nyquist filter having a roll-off factor of 0.3 and 0.5. Furthermore, the demodulator 501c passes the control signal through a 6-tap decision feedback equalizer (DFE), thereby removing an inter symbol interference (ISI) so as to compensate any remaining phase error.

The differential decoder 501d decodes the outputted signal from the demodulator 501c, so as to recover the initial control signal, and transmits the recovered initial control signal (DRX) to the POD interface unit 503. The differential decoder 501d synchronizes the recovered signal (DRX) with a clock (CRX) having a speed twice of that of a symbol rate and transmits the synchronized signal to the POD interface unit 503. More specifically, the differential decoder 501d synchronizes the recovered signal (DRX) with a clock having a cycle identical to a ½ cycle of the symbol rate and outputs the signal. The frequency synthesizer 501f includes a local oscillator of 104 to 174 megahertz (MHz) for down-converting the received control signal to a bandwidth of 70 to 130 megahertz (MHz).

The OOB transmitter 502 includes a modulator 502a, a direct digital frequency synthesizer (DDFS) 502b, a power shaper 502c, a D/A converter 502d, a second gain amplifier 502e, a power controller 502f, and a phase loop lock (PLL) 502g. The modulator 502a is a block converting frequency spectrum, which includes a square-root Nyquist filter, an interpolation filter, and a quadrature modulator. The modulator 502a receives signals, such as ITX, QTX, ETX, and so on, from the POD interface unit 503, passes the received signals through the square-root Nyquist filter having a roll-off factor of 0.3 and 0.5, and modifying the symbol to a sample rate through the interpolation filter. At this point, parameter values of the filters and the number of taps are controlled so as to minimize a main tone contrast noise.

The power shaper 502c receives the signal outputted from the modulator 502a, and converts the received signal to a level suitable for the cable head-end 401. The D/A converter 502d receives the signal outputted from the power shaper 502c, and converts the received signal to an analog signal. In addition, the second gain amplifier 502e receives the signal outputted from the D/A converter 502d, and converts the received signal to a size suitable for the cable head-end 401. The second gain amplifier 502e then transmits a signal having a bandwidth of 5 to 42 megahertz (MHz) to the cable head-end 401. The DDFS 502b puts in table and stores the required values for converting the frequency spectrum. The power controller 502f controls a default value of a power amplifier, and uses the value received from the POD interface unit 503 to control the amplified value of the second gain amplifier 502e.

The POD interface unit 503 includes a connector 503a connecting the POD interface unit 503 to the POD module 404 or the PC memory card. The connector 503a receives the control signal from the OOB receiver 501 and transmits the received control signal to the POD module 404. In addition, the connector 503a receives the control signal outputted from the POD module 404 and transmits the signal outputted from the POD module 404 to the OOB transmitter 502 or the digital cable receiver (or host). The connector 503a is connected to the OOB multiplexer 503b, a first TS multiplexer 503c, a second TS multiplexer 503d, and a personal computer memory card international association (PCMCIA) controller 503h. The OOB multiplexer 503b receives the control signal from the differential decoder 501d of the OOB receiver 501 and, then, transmits the control signal received from the differential decoder 501d to the POD module 404. Furthermore, the OOB multiplexer 503b transmits the signal outputted from the POD module 404 to the modulator 502a of the OOB transmitter 502.

The TS input selecting part 503e receives an in-band signal from outside (e.g., the cable head-end) and, then, selectively transmits the received in-band signal to the first TS multiplexer 503c. The TS multiplexers 503c and 503d receive the in-band signal (i.e., MPEG-2 TS), which is transmitted from the cable head-end 401. Then, the TS multiplexers 503c and 503d multiplexes the received in-band signal and transmits the multiplexed signal to the POD module 404. The signal outputted from the POD module 404 is transmitted to the TS input selector 503e through the second TS multiplexer 503d. And, the TS input selector 503e transmits the received signal to a descrambler 503f and a TS output selector 503g. Furthermore, the TS output selector 503g outputs the received signal to the digital cable receiver (or host).

The personal computer memory card international association (PCMCIA) controller 503h provides an interface for connecting the connector to the POD module 404 or the memory PC card. A VPP switch 503i and a VCC switch 503k are both connected to the connector 503a. The VPP switch 503i and the VCC switch 503k sense the connection with the POD module 404 or the PC memory card and automatically apply power or perform initialization based upon the connection. Such process is referred to as a hot-swap. A hot-swap controller 503j controls the VPP switch 503i and the VCC switch 503k.

A host interface 503l provides an interface for a connection with a CPU of the digital cable receiver. The host interface 503l has a function of reading and writing a signal to an internal register 503m, thereby being capable of inputting and outputting a signal by using a clock faster than an I²C interface, which is generally provided from a chip. The register 503m is connected to the hot-swap controller 503j, and is also connected to the PCMCIA controller 503h and the host interface 503l. An interrupt generator 503n either externally receives an interrupt or generates an interrupt in emergency situations, thereby controlling the circuit in accordance with the corresponding interrupt situation.

The in-band signal received from the cable head-end 401 can be transmitted to the digital cable receiver (or host) through three different paths. The first path consists of the in-band signal passing through in the order of the second TS multiplexer 503d, the input selector 503e, and the output selector 503g and, then, being transmitted to the digital cable receiver (or host). The second path consists of first transmitting the received in-band signal to the POD module 404 through the first TS multiplexer 503c and the connector 503a, then transmitting the received in-band signal from the POD module 404 through the connector 503a, the second TS multiplexer 503d, the input selector 503e, and the output selector 503g and to the digital cable receiver. And, finally, the third path consists of transmitting the in-band signal from the POD module 404 through the connector 503a, the second TS multiplexer 503d, and the input selector 503e to the descrambler 503f and, then, descrambling the copy protection encoding of the in-band signal, which is encoded from the POD module 404, through the descrambler 503f and, then, transmitting the descrambled signal through the TS output selector 504g to the digital cable receiver.

The digital cable receiver according to the present invention has the following advantages. First, the OOB receiver and transmitter and the POD interface unit can be integrated to be formed in a single chip, thereby enhancing the system function and reducing fabrication cost. Moreover, since the present invention can support not only the POD interface unit, but also the host interface as well as the PC card interface, thereby expanding the scope of application. Furthermore, a multiplexing function is including in the inputting and outputting of the in-band signal, thereby enabling more various forms of data to be outputted. And, finally, by performing a reading and writing function of an internal register to a host interface, instead of an I²C interface, which is generally provided from a chip, so as to enable an interface from a faster clock, thereby optimizing the system.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A digital cable receiver, comprising:
an out-of-band (OOB) receiver receiving an out-of-band signal outputted from a cable head-end;
a point of deployment (POD) interface transmitting the out-of-band signal outputted from the cable head-end and a transport stream outputted from POD module, and receiving the transport stream scrambled at the POD module; and
an out-of-band (OOB) transmitter outputting the out-of-band signal outputted from the POD interface.

2. The digital cable receiver of claim 1, wherein the out-of-band (OOB) receiver comprises:
a first gain amplifier amplifying the out-of-band signal outputted from the cable head-end,
an A/D converter converting the out-of-band signal amplified from the first gain amplifier to a digital signal;
a demodulator demodulating the signal outputted from the A/D converter; and
a differential decoder decoding the signal outputted from the demodulator and transmitting the decoded signal to the POD interface.

3. The digital cable receiver of claim 2, wherein the demodulator comprises:
a filter compensating a channel error of the signal outputted from the A/D converter; and
an equalizer compensating a phase error of the signal outputted from the A/D converter.

4. The digital cable receiver of claim 2, wherein the differential decoder synchronizes the decoded signal with a clock having a cycle identical to a ½ cycle of a symbol rate.

5. The digital cable receiver of claim 2, further comprising a gain controller controlling an amplified value given from the gain amplifier in accordance with the signal outputted from the A/D converter.

6. The digital cable receiver of claim 1, wherein the out-of-band (OOB) transmitter comprises:
a modulator modulating a frequency spectrum of the out-of-band signal outputted from the POD interface;
a power shaper converting a level of the out-of-band signal outputted from the modulator;
a D/A converter converting the out-of-band signal outputted from the modulator to an analog signal; and
a second gain amplifier amplifying the signal outputted from the D/A converter, and transmitting the amplified signal to the cable head-end.

7. The digital cable receiver of claim 6, further comprising a digital frequency synthesizer storing data related with frequency spectrum modulating of the out-of-band signal, and transmitting the stored data to the modulator.

8. The digital cable receiver of claim 1, further comprising a power controller controlling an amplified value of the gain amplifier in accordance with the signal outputted from the POD interface.

9. The digital cable receiver of claim 1, wherein the POD interface comprises:
an out-of-band (OOB) multiplexer transmitting the out-of-band signal outputted from the OOB receiver to the POD module, and transmitting the outputted put-of-band signal to the OOB transmitter;
a first transport stream (TS) multiplexer transmitting the transport stream outputted from the cable head-end to the POD module; and
a second transport stream (TS) multiplexer receiving the transport stream outputted from the POD module.

10. The digital cable receiver of claim 9, further comprising:
a transport stream (TS) input selector selectively transmitting the transport stream outputted from the cable head-end to the first TS multiplexer; and
a descrambler descrambling the transport stream outputted from the TS input selector.

11. The digital cable receiver of claim 9, further comprising:
a connector connecting the POD module to the OOB multiplexer, the first TS multiplexer, and the second TS multiplexer; and
at least one switch sensing the connection between the POD module and the connector.

12. The digital cable receiver of claim 1, wherein the OOB receiver, the OOB transmitter, and the POD interface are formed in a single chip.
